(19) United States
(12) Patent Application Publication
(10) Pub. No.: US 2004/0123409 A1
(43) Pub. Date: Jul. 1, 2004

(54) Electric toothbrush having rotatably oscillating and pulsating bristle heads

(76) Inventor: Robert G. Dickie, Newmarket (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/735,875

(22) Filed: Dec. 16, 2003

Related U.S. Application Data
(60) Provisional application No. 60/433,509, filed on Dec. 16, 2002.

(51) Int. Cl. A61C 17/22

(52) U.S. Cl. 15/22.1

(57) ABSTRACT

There is provided a toothbrush head for an electric toothbrush, in accordance with an aspect of the present invention. A camshaft passes substantially through the main body of the toothbrush head and is adapted for connection to a motor to rotate the shaft. The camshaft has a first section that defines a longitudinal axis. A first bristle head is rotatably mounted to the main body for rotation between a first rotational position and a second rotational position. A second bristle head is slidably mounted to the main body proximate the tip and is moveable between a first position proximate to the longitudinal axis and a second position spaced from the longitudinal axis. The rotation of the camshaft drives the first bristle head between the first rotational position and the second rotational position and second bristle head from the first position to the second position.

### CROSS-REFERENCE

This application is based on, and claims priority from, U.S. Provisional Application Serial No. 60/433,509, filed Dec. 16, 2002.

### FIELD OF THE INVENTION

This invention relates to electric toothbrushes and particularly to an electric toothbrush that comprises an inline arrangement of a rotary oscillating bristle head, and a pulsating bristle head.

### BACKGROUND

The use of manual toothbrushes has, of course, been known for many years. Indeed, the use of mechanical toothbrushes, typically those that are electrically driven, has been known for a number of years. The purpose, in any event, is to clean the teeth, usually with a toothbrush that comprises a plurality of bristles that are used in conjunction with a dentifrice. Very often, the dentifrice is mildly abrasive.

The dental profession has propounded, for many years, a technique known as the “Bass Technique” which, if properly performed, is said to achieve superior results in terms of cleaning one's teeth using a manual. toothbrush. Essentially, the Bass Technique requires the user to position a manual toothbrush over a zone of the teeth, and then to use very short strokes so as to more or less vibrate the brush at that zone where the brush has been located. This short-stroke brushing should continue for a period of time—typically, twenty strokes to forty strokes—so as to remove any foreign material from that zone. The brush is then repositioned and typically another twenty to forty short strokes are performed. Because each zone is very small, the Bass Technique can be very time consuming. Moreover, since it is a requirement that the strokes be very short which, in turn, requires excellent muscle control, exercising the Bass Technique can be very tiring.

The theory is that, at the end of any given stroke, the bristles will flex so as to become oriented in such a manner that the ends of the bristles point generally away from the direction of the travel of the bristles across the teeth. However, at the beginning of the next stroke, in the opposite direction, the still-flexed bristles will then be pointed in the direction of the stroke and this may cause the bristle to chisel the foreign material away from the teeth for a moment before the bristle again begins to flex so as to sweep across the surface of the tooth in the zone where it is located.

The Bass Technique has been applied to a variety of electric toothbrushes. U.S. Pat. No. 5,259,083, issued Nov. 9, 1993 to Stansbury, and reissued as RE35941, teaches a plurality of tuft blocks which are mounted in sliding relationship one with another, and which are driven by a camshaft so as to reciprocate inwardly and outwardly from the head of the toothbrush assembly. Toothbrushes in keeping with the teaching of this patent are sold in association with the BUTLER trademark. A similar cam driven structure is taught in U.S. Pat. No. 5,778,474, issued Jul. 14, 1998, to Shek.

Another manner for brushing teeth comprises a variation of the Bass Technique, whereby oscillatory movement is imparted to a toothbrush. Of course, such oscillatory movement is not capable of being executed manually. Most electric toothbrushes provide groups of bristles in concentric circles, where the brush head thus provided is rotated or, more usually, it is reciprocally rotated.

This oscillatory technique has been implemented in a variety of electric toothbrushes. For example, U.S. Pat. No. 5,120,225 issued to Amit teaches a mechanical toothbrush by which longitudinal reciprocation of the handle transfers oscillatory rotation to a rotatable bristle tufted head that is mounted between two longitudinally spaced clusters of fixed bristle tufts.

U.S. Pat. No. 5,625,916 issued May 6, 1997 to McDougall, teaches an electric toothbrush having a circular bristle head that oscillates in a rotary manner, driven by a rotatable shaft which couples to a slot in one side of the bristle head and thereby functions as a cam. Toothbrushes in keeping with the teachings of this invention are sold in the market in association with a COLGATE trademark.

Presently, purchasers of electric toothbrushes have been forced to choose between toothbrushes implementing the Bass technique or the oscillatory technique. Thus there is a need to have a single electric toothbrush that incorporates both techniques to achieve maximal cleaning.

### SUMMARY

There is provided a toothbrush head for an electric toothbrush, in accordance with an aspect of the present invention. The toothbrush head has a main body extending between a coupling interface and a tip. A camshaft passes substantially through the main body and is adapted for connection to a motor to rotate the shaft. The camshaft has a first section proximate the coupling interface which defines a longitudinal axis.

A first bristle head is rotatably mounted to the main body proximate the tip. The first bristle head is mounted to rotate about a rotational axis between a first rotational position and a second rotational position. The first bristle head is provided with a plurality of bristles.

A second bristle head is slidably mounted to the main body proximate the tip. The second bristle head is moveable between a first position proximate to the longitudinal axis and a second position spaced from the longitudinal axis. The second bristle head has a plurality of bristles.

The first bristle head is drivable by rotation of the camshaft between the first rotational position and the second rotational position. The second bristle head is drivable by rotation of the camshaft from the first position to the second position.

In another aspect of the present invention, the toothbrush head further has a plurality of bristles fixedly mounted to the main body.

In an alternative aspect of the present invention, the first bristle head further includes a first cam follower adapted for abutment by the camshaft to rotate the first bristle head from the first rotational position to the second rotational position.

In a further aspect of the present invention, the first bristle head further comprises a second cam follower adapted for abutment by the camshaft to rotate the first bristle head from the second rotational position to the first rotational position.

In yet another aspect of the present invention, the rotation of the first bristle head from the first rotational position to the second rotational position is in a first rotational direction. The rotation of the first bristle head from the second rotational position to the first rotational position is in a second rotational direction. The second rotational direction is opposed to the first directional rotation.

In yet a further aspect of the present invention, the camshaft is adapted such that the abutment of the first cam follower occurs 180 degrees out of phase with the abutment of the second cam follower over a full rotation of the camshaft.

In still another aspect, the camshaft is adapted to abut the first and second cam followers such that the first bristle head undergoes reciprocal rotation between the first and second rotational positions while the camshaft is fully rotated.

In a still further aspect, the second bristle head further includes a base portion. The base portion has a slot adapted to receive a pulsating portion of the camshaft. The pulsating portion of the camshaft is non-collinear with the longitudinal axis. The slot is adapted to transmit movement in a lateral direction to the second bristle head where the lateral direction is generally parallel to the bristle and perpendicular to the longitudinal axis.

In another aspect, the first bristle head further includes a base portion. The base portion has a slot adapted to receive an oscillating portion of the camshaft. The oscillating portion of the camshaft is non-collinear with the longitudinal axis. The slot is adapted to transmit rotational motion to the first bristle head about a central axis of the first bristle head.

In another embodiment of the present invention, there is provided an electric toothbrush having a toothbrush head with the features described above.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which presently preferred embodiment(s) of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a plan view of a first embodiment of a toothbrush in accordance with the present invention;

FIG. 2 is a partial sectional view of the toothbrush of FIG. 1 taken along line A-A;

FIG. 3 is a perspective view of the toothbrush head of FIG. 1;

FIG. 4 is a plan view of the toothbrush head of FIG. 3;

FIG. 5 is a side elevation of the toothbrush head of FIG. 3;

FIG. 6 is a sectional view taken along line B-B in FIG. 4, with the internal drive shaft in a first position;

FIG. 7 is a sectional view taken along line C-C in FIG. 5 with the internal drive shaft in the first position;

FIG. 8 is similar to FIG. 6, but with the drive shaft rotated 180°;

FIG. 9 is similar to FIG. 7, but with the drive shaft rotated 180°;

FIG. 10 is a perspective view of a pulsating bristle head of the toothbrush head of FIG. 1;

FIG. 11 is a plan view of a second embodiment of a toothbrush in accordance with the present invention;

FIG. 12 is a partial sectional view of the toothbrush of FIG. 11 taken along line D-D;

FIG. 13 is a perspective view of the toothbrush head of FIG. 11;

FIG. 14 is a plan view of the toothbrush head of FIG. 13;

FIG. 15 is a side elevation of the toothbrush head of FIG. 13;

FIG. 16 is a perspective view of a third embodiment of a toothbrush head in accordance with the present invention;

FIG. 17 is a plan view of the toothbrush head of FIG. 16;

FIG. 18 is a side elevation of the toothbrush head of FIG. 16;

FIG. 19 is a sectional view taken along line G-G in FIG. 17, with the internal drive shaft in a first position;

FIG. 20 is a sectional view taken along line H-H in FIG. 18 with the internal drive shaft in the first position;

FIG. 21 is similar to FIG. 19, but with the drive shaft rotated 180°;

FIG. 22 is similar to FIG. 20, but with the drive shaft rotated 180°; and

FIG. 23 is a perspective view of the drive shaft arrangement of the third embodiment.

### DETAILED DESCRIPTION

The novel features which are believed to be characteristic of the present invention, as to its structure, organization, use and method of operation, together with further objectives and advantages thereof, will be better understood from the following discussion in combination with the accompanying drawings.

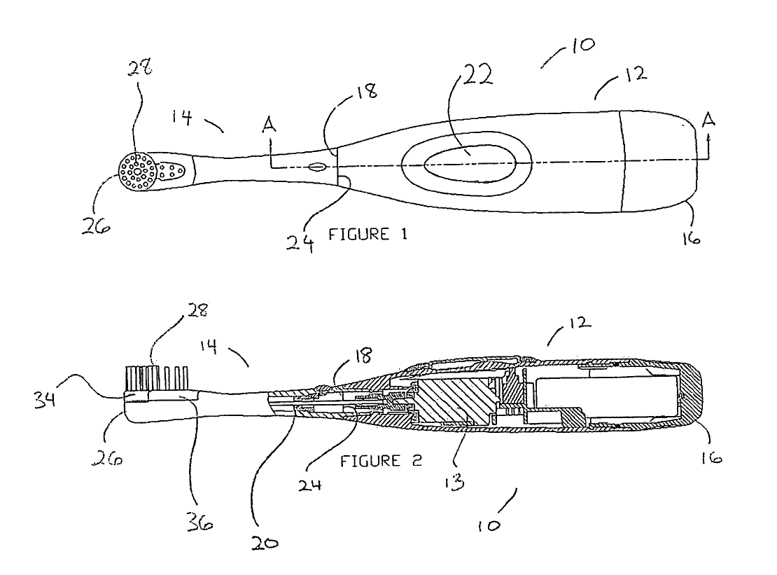

FIGS. 1 to 9 show a first embodiment of a toothbrush 10 in accordance with the present invention. Toothbrush 10 is composed of a power handle or handle section 12 coupled to a toothbrush head 14. Handle section 12 is a generally cylindrical body extending from a base 16 to coupling interface 18. As shown in FIG. 1, the diameter of the body of handle section 12 decreases towards the coupling interface 18. Handle section 12 will generally house a motor 13 to drive a camshaft or central shaft 20 and a battery to power the motor. In addition, base portion 12 will often incorporate an activator 22 to start and stop the motor.

Toothbrush head 14 is a generally cylindrical main body extending between a coupling interface 24 and a tip 26. Tufts of bristles 28 extend outwardly near tip 26, as seen in FIG. 2, in a single direction.

Toothbrush head 14 and handle section 12 may be coupled together using a variety of configurations known in the art. The important feature of this coupling is that the drive shaft or central shaft 20, which extends through toothbrush head 14, is rotatably driven by a motor in handle section 12. While toothbrush head 14 is shown and described as being detachable from handle section 12, toothbrush head 14 and handle section 12 may be incorporated into a single unit.

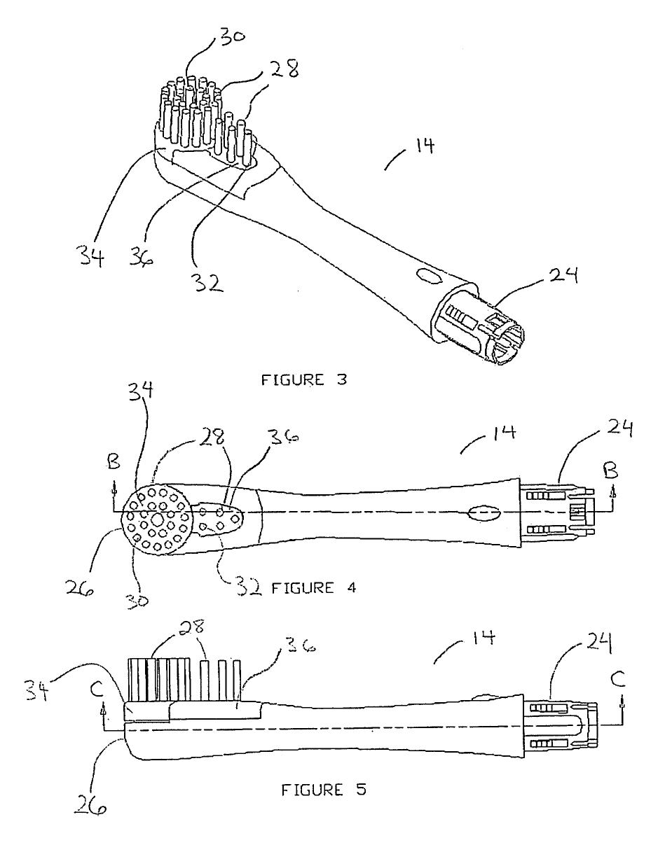

As shown in FIG. 3, bristles 28 are composed of two sets of tufts of bristles: reciprocating bristles 30 and pulsating bristles 32. Reciprocating bristles 30 are mounted in separate tufts on a first bristle head or circular bristle block 34. Circular bristle block 34 is rotatably mounted to the tip 26 of toothbrush head 14. Pulsating bristles 32 are mounted to a second bristle head or pulsating bristle block 36. Pulsating bristle block 36 is mounted next to circular bristle block 34 for motion perpendicular to the longitudinal axis of toothbrush head 14.

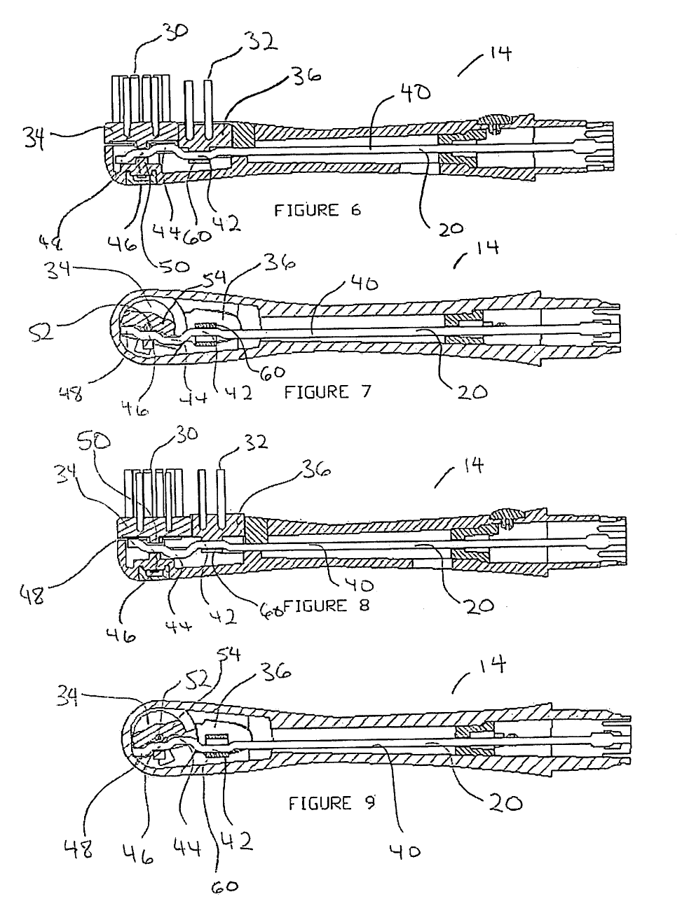

As shown in FIGS. 6 through 9, central shaft 20 is composed of five sections. For the purposes of describing the positioning of the various sections, reference will first be made to FIG. 6. Central shaft 20 begins with a first or main section 40 which extends from coupling interface 24 through most of toothbrush head 14. Main section 40 defines a longitudinal axis and lies in a generally horizontal plane passing through toothbrush head 14 as shown in FIG. 6. Central shaft 20 continues to a pulsating section 42 positioned below pulsating block 36. Pulsating section 42 lies parallel to and below the horizontal plane in which main section 40 is positioned. Central shaft 20 continues to a first oscillating section 44 which lies parallel to and above the horizontal plane in which main section 40 is positioned. A spindle section 46 of central shaft 20 is adjacent to first oscillating section 44 and lies within the horizontal plane. Finally, central shaft 20 terminates in a second oscillating section 48 which lies parallel to and below the horizontal plane. Preferably, the distance between second oscillating section 48 and the horizontal plane is equal to the distance between first oscillating section 44 and the horizontal plane.

The sections of central shaft 20 will now be described with reference to FIG. 7. Main section 40 is at an angle from a vertical plane that bisects toothbrush head 14. (In FIG. 7, this vertical plane would rise out of the page.) Pulsating section 42 is above the axis defined by main section 40, as is second oscillating section 48. First oscillating section 44 lies below the axis defined by main section 40. Spindle section 46 is generally aligned with main section 40.

Spindle section 46 is mounted within a spindle bearing 50 below circular bristle block 34. As the motor rotates the shaft, spindle section 46 remains in position with respect to toothbrush head 14. The other sections, however, will rotate about the axis defined by main section 40. FIGS. 8 and 9 show the toothbrush head with central shaft 20 rotated by 180° with respect to the position shown in FIGS. 6 and 7.

The actions of each bristle block will now be described in more detail. Circular bristle block 34 is rotatable about a rotation axis at pin 52 which connects circular bristle block 34 to the main body of toothbrush head 14. Central shaft 20 lies at an angle to the bisecting vertical plane of toothbrush head 14 so that pin 52 does not interfere with spindle section 46. First and second oscillating sections 44 and 48 act as cams on a cam follower 54 projecting below the base of circular bristle block 34. As central shaft 20 rotates, first and second oscillating sections 44 and 48 move in opposite directions (as viewed in FIGS. 7 and 9) away from the axis defined by main section 40. The movement of first oscillating sections 44 against cam follower 54 causes circular bristle block 34 to rotate about pin 52 from the first rotational position shown in FIG. 7 to a second rotational position shown in FIG. 9 in a counter-clockwise direction (with reference to FIGS. 7 and 9). After first oscillating section 44 is not longer in contact with cam follower 54, second oscillating section 48 abuts cam follower 54 to rotate circular bristle block 34 from the position shown in FIG. 9 back to that in FIG. 7 in a clockwise direction (with reference to FIGS. 7 and 9). The angle through which bristle head 34 rotates is determined by the distance between the longitudinal axis defined by the central shaft and the first and second oscillating sections 44 and 48 as well as the shape and size of cam follower 54. Cam follower 54 as shown in FIGS. 7 and 9 is actually composed of a pair of cam followers, one of which is abutted by first oscillating section 44 and the other of which is abutted by second oscillating section 48. Preferably, first and second oscillating sections 44 and 48 are equidistant from the longitudinal axis. In addition, in the embodiment shown, first and second oscillating sections 44 and 48 are 180° out of phase, first and second oscillating section may be out of phase at lesser or greater intervals than 180°.

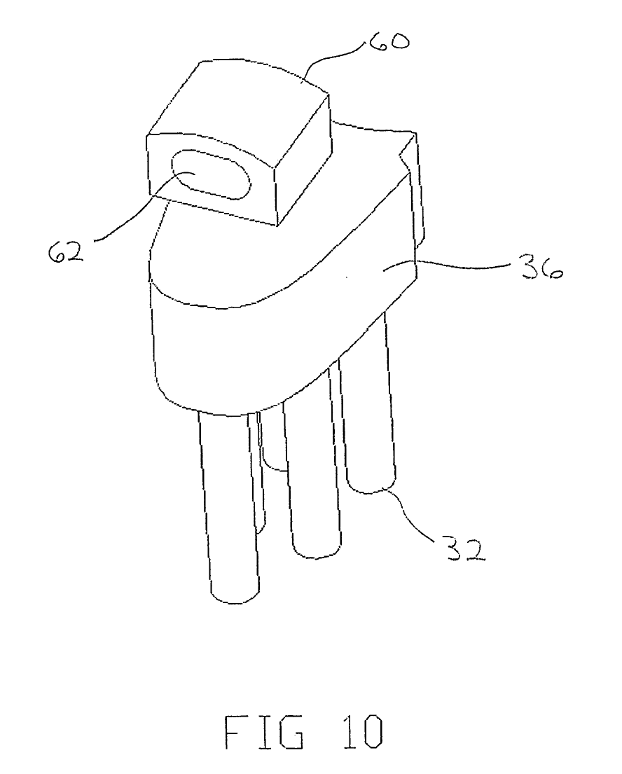

Pulsating bristle block 36 has a cam follower 60 projecting downwardly therefrom, as shown in FIG. 10. Pulsating section 42 of central shaft 20 passes through an opening 62 having an obround cross-section. Pulsating bristle block 36 is maintained within toothbrush head 14 in this manner and is not otherwise affixed to the casing of toothbrush head 14. (A cavity within toothbrush head accommodates the sliding motion in the vertical direction.) As central shaft 20 is rotated by the motor, pulsating section 42 of the central shaft moves vertically from a first position as shown in FIG. 6 to a second position shown in FIG. 8. The obround cross-section of opening 62 has a major axis in the horizontal direction and a minor axis in the vertical direction. The minor axis is only slightly larger that the diameter of central shaft 20. As a result, when pulsating section 42 will rise and fall as pulsating section 42 moves upwardly and downwardly with respect to the longitudinal axis. The major axis is sized such that little or no lateral motion is imparted to pulsating bristle block 36 as pulsating section moves vaertically with respect to central shaft 20. In addition, cam follower 62 is positioned away from the central vertical axis of pulsating bristle block 36 so as to accommodate the angled positioning of central shaft 20.

Thus, as central shaft 20 is rotated, pulsating bristle block 36 is moved into and out of the teeth while circular bristle block 34 is rotated about pin 52 in a reciprocating manner. As the bristles are passed over teeth during cleaning, two advantageous methods of cleaning are simultaneously applied.

FIGS. 11 through 15 show an alternative embodiment of toothbrush head 14. The only difference with the first embodiment is that toothbrush head 14 has a third stationary set of bristles 70 generally surrounding pulsating bristles 30. The third set of bristles will perform a third form of cleaning as the toothbrush is moved in a longitudinal direction by the user.

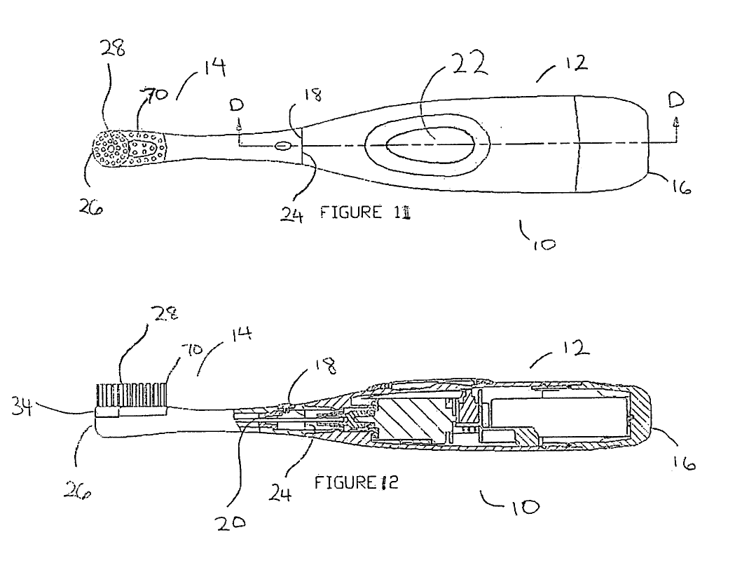

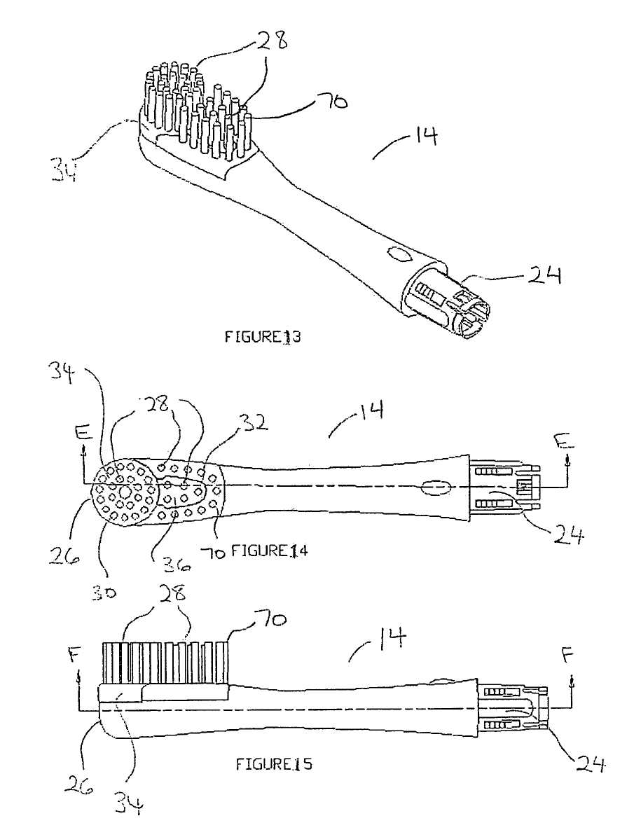

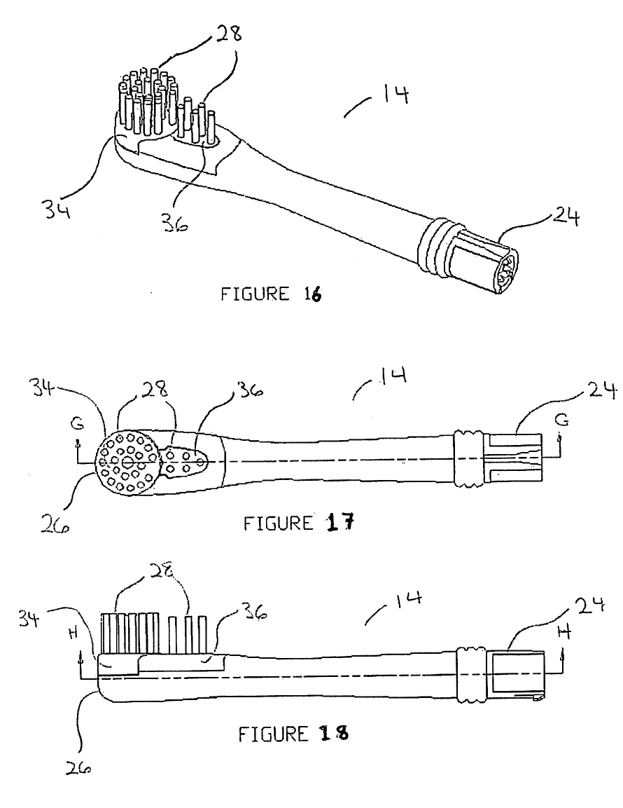

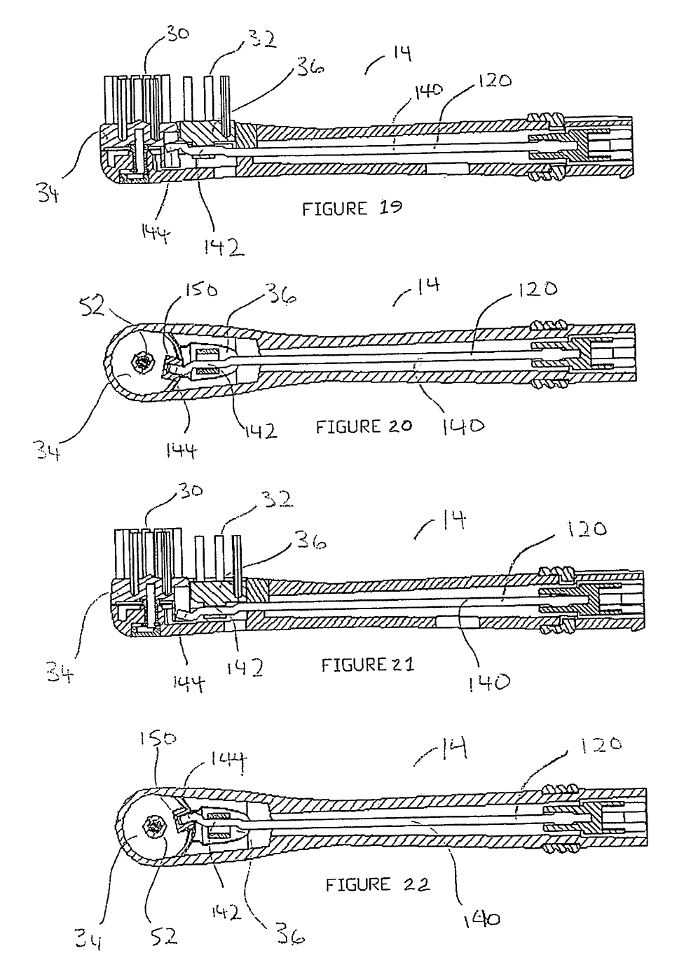

FIGS. 16 through 23 show a third embodiment of toothbrush head 14. In this embodiment, central shaft 120 is composed of three sections. The first is a main section 140 which extends from coupling interface 24 through much of toothbrush handle 14. Main section 140 defines a longitudinal axis. Central shaft 120 continues to pulsating section 142 which lies parallel to the longitudinal axis, but is spaced therefrom. Central shaft 120 terminates in an oscillating section 144. Oscillating section 144, as shown in FIG. 19, is not parallel to the longitudinal axis. It begins at a point further from the longitudinal axis than pulsating section 142 and is then angled inwardly towards the longitudinal axis.

A spindle projection 146 extends downwardly from a portion of the toothbrush head to act as a bearing for the tipwards end of main section 140.

Circular bristle block 34 is oscillated in a reciprocating manner using a somewhat different manner than in the first embodiment. Circular bristle block 34 has a cam follower 150 located near the periphery of the bristle block furthest from the tip of toothbrush head 14. Cam follower 150 is composed of at least two downwardly projecting walls having a slot therebetween in which oscillating section 144 is placed. Oscillating section 144 is angled such that it is aligned with pin 52 of circular bristle block 34 throughout the complete revolution of central shaft 120. The rotation of central shaft 120 causes oscillating section 144 to act as a cam and push against double-sided cam follower 150. The rotation of central shaft 20 imparts rotational movement to the first bristle block. This results in the reciprocating rotation of circular bristle block 34 about pin 52.

Pulsating bristle block 36 is moved by pulsating section 142 in the same manner as described in the first embodiment. However, in this case, cam follower 60 is now centrally located on the base of pulsating bristle block 36 as the main section lies in a central longitudinal axis.

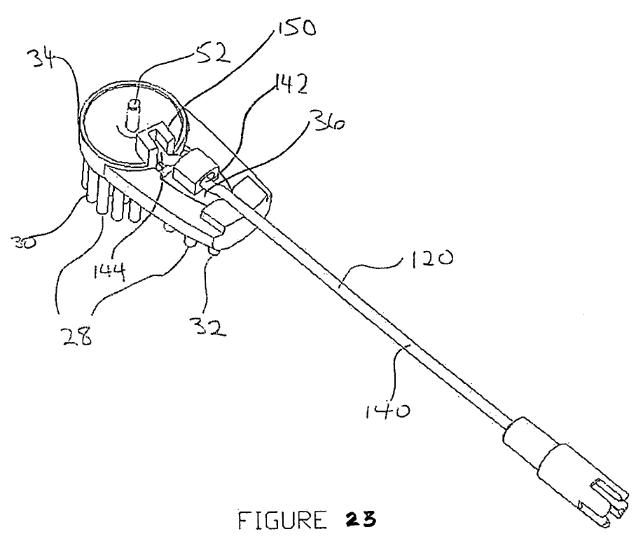

FIGS. 19 and 20 show toothbrush head 14 with the central shaft 120 in a first position. Pulsating bristle block 36 is in a raised position and circular bristle block 34 is angled to a first position. In FIGS. 21 and 22, central shaft 120 is rotated by 180°. Pulsating block 36 is in a lower position and circular bristle block 34 is angled to a second position.

While not explicitly shown in this embodiment, it would be obvious to those skilled in the art to add a set of stationary bristles to toothbrush head 14 to augment the cleaning process.

The embodiments shown describe a detachable toothbrush head. However, the mechanisms described above could be incorporated into a unitary toothbrush design where the toothbrush head is not detachable or replaceable. In such a case, the central shaft may be affixed to the motor directly rather than through a coupling.

In addition, a variety of different configurations of the bristle blocks may be designed. For example, the pulsating block may be located closer to the tip than the circular blocks. In another embodiment, multiple pulsating blocks may be included with alternating pulsing action or may be synchronized. A pair of bristle blocks may be mounted on either side of the circular bristle block.

Each of the bristle blocks in the described embodiments are moved between their first and second positions by a dual cam action. Alternatively, a single cam action could be used to move the bristle blocks from a first position to a second position. A biasing means, such as a spring, could be used to return the bristle block from the second position to the first position. In a further alternative, the cam follower of the pulsating bristle block could be adapted such that the camshaft only acts to move the pulsating bristle block from the first position to the second position. The pressure from the user pressing the bristles against the user's teeth will cause the pulsating bristle block to return to the first position.

Central shaft 20 and 120 as shown is a camshaft having a constant diameter, with sections bent such that they are no longer collinear with main sections 40 and 140. It will be obvious to those skilled in the art that traditional cam discs could be mounted on a single straight camshaft to achieve the same movement of the bristle blocks.

In another variation on the present invention, the circular bristle block and cams on the central shaft may be adapted for continuous rotation in a single direction. One method of incorporating this motion could be to have a bevel gear mounted to the central shaft with a corresponding bevel gear mounted at a right angle to the base of the circular bristle block.

In another variation on the present embodiments, the motor may be adapted to only partially rotate central shaft 20 in one direction followed by a partial rotation in a second direction opposite to the first direction. The organization of cams and cam followers would be adjusted accordingly to effect the same motions described above.

Other variations of the above principles will be apparent to those who are knowledgeable in the field of the invention, and such variations are considered to be within the scope of the present invention. Other modifications and/or alterations may be used in the design and/or manufacture of the apparatus of the present invention, without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially perpendicular is intended to mean perpendicular, nearly perpendicular and/or exhibiting characteristics associated with perpendicularity.

1. A toothbrush head for an electric toothbrush, said toothbrush head comprising:
(a) a main body extending between a coupling interface and a tip;
(b) a camshaft passing substantially through said main body, said camshaft being adapted for connection to a motor to rotate said shaft, said camshaft having a first section proximate said coupling interface, said first section defining a longitudinal axis;
(c) a first bristle head rotatably mounted to said main body proximate said tip, said first bristle head being mounted to rotate about a rotational axis between a first rotational position and a second rotational position, said first bristle head having a plurality of bristles;
(d) a second bristle head slidably mounted to said main body proximate said tip, said second bristle head being moveable between a first position proximate to said longitudinal axis and a second position spaced from said longitudinal axis, said second bristle head having a plurality of bristles;
(e) wherein said first bristle head is drivable by rotation of said camshaft between said first rotational position and said second rotational position; and
(f) wherein said second bristle head is drivable by rotation of said camshaft from said first position to said second position.

2. A toothbrush head as claimed in claim 1 further comprising a plurality of bristles fixedly mounted to said main body.

3. A toothbrush head as claimed in claim 1 wherein said first bristle head further comprises a first cam follower adapted for abutment by said camshaft to rotate said first bristle head from said first rotational position to said second rotational position.

4. A toothbrush head as claimed in claim 3 wherein said first bristle head further comprises a second cam follower adapted for abutment by said camshaft to rotate said first bristle head from said second rotational position to said first rotational position.

5. A toothbrush head as claimed in claim 4 wherein said rotation of said first bristle head from said first rotational position to said second rotational position is in a first rotational direction and wherein said rotation from said second rotational position to said first rotational position is in a second rotational direction, said second rotational direction being opposed to said first directional rotation.

6. A toothbrush head as claimed in claim 4 wherein said camshaft is adapted such that said abutment of said first cam follower occurs 180 degrees out of phase with said abutment of said second cam follower over a full rotation of said camshaft.

7. A toothbrush head as claimed in claim 4 wherein said camshaft is adapted to abut said first and second cam followers such that said first bristle head undergoes reciprocal rotation between said first and second rotational positions while said camshaft is fully rotated.

8. A toothbrush head as claimed in claim 1 wherein said second bristle head further comprises a base portion, said base portion having a slot adapted to receive a pulsating portion of said camshaft, said pulsating portion of said camshaft being non-collinear with said longitudinal axis, said slot being adapted to transmit movement in a vertical direction to said second bristle head, said vertical direction being generally parallel to said bristle and perpendicular to said longitudinal axis.

9. A toothbrush head as claimed in claim 1 wherein said first bristle head further comprises a base portion, said base portion having a slot adapted to receive an oscillating portion of said camshaft, said oscillating portion of said camshaft being non-collinear with said longitudinal axis, said slot being adapted to transmit rotational motion to said first bristle head about a central axis of said first bristle head.

10. An electric toothbrush having a power handle and a toothbrush head, said power handle having a motor, said toothbrush head comprising:
(a) a main body extending from said power handle and a tip;
(b) a camshaft passing substantially through said main body, said camshaft being mounted for rotation to said motor, said camshaft having a first section proximate said motor, said first section defining a longitudinal axis;
(c) a first bristle head rotatably mounted to said main body proximate said tip, said first bristle head being mounted to rotate about a rotational axis between a first rotational position and a second rotational position, said first bristle head having a plurality of bristles;
(d) a second bristle head slidably mounted to said main body proximate said tip, said second bristle head being moveable between a first position proximate to said longitudinal axis and a second position spaced from said longitudinal axis, said second bristle head having a plurality of bristles;
(e) wherein said first bristle head is drivable by rotation of said camshaft between said first rotational position and said second rotational position; and
(f) wherein said second bristle head is drivable by rotation of said camshaft from said first position to said second position.

11. An electric toothbrush as claimed in claim 10 further comprising a plurality of bristles fixedly mounted to said main body.

12. An electric toothbrush as claimed in claim 10 wherein said first bristle head further comprises a first cam follower adapted for abutment by said camshaft to rotate said first bristle head from said first rotational position to said second rotational position.

13. An electric toothbrush as claimed in claim 12 wherein said first bristle head further comprises a second cam follower adapted for abutment by said camshaft to rotate said first bristle head from said second rotational position to said first rotational position.

14. An electric toothbrush as claimed in claim 13 wherein said rotation of said first bristle head is from said first rotational position to said second rotational position is in a first rotational direction and wherein said rotation from said second rotational position to said first rotational position is in a second rotational direction, said second rotational direction being opposed to said first directional rotation.

15. An electric toothbrush as claimed in claim 13 wherein said camshaft is adapted such that said abutment of said first cam follower occurs 180 degrees out of phase with said abutment of said second cam follower over a full rotation of said camshaft.

16. An electric toothbrush as claimed in claim 13 wherein said camshaft is adapted to abut said first and second cam followers such that said first bristle head undergoes reciprocal rotation between said first and second rotational positions while said camshaft is fully rotated.

17. An electric toothbrush as claimed in claim 10 wherein said second bristle head further comprises a base portion, said base portion having a slot adapted to receive a pulsating portion of said camshaft, said pulsating portion of said camshaft being non-collinear with said longitudinal axis, said slot being adapted to transmit movement in a vertical direction to said second bristle head, said vertical direction being generally parallel to said bristle and perpendicular to said longitudinal axis.

18. An electric toothbrush as claimed in claim 10 wherein said first bristle head further comprises a base portion, said base portion having a slot adapted to receive an oscillating portion of said camshaft, said oscillating portion of said camshaft being non-collinear with said longitudinal axis, said slot being adapted to transmit rotational motion to said first bristle head about a central axis of said first bristle head.
